(19) United States
(12) Patent Application Publication
(10) Pub. No.: US 2010/0310777 A1
(43) Pub. Date: Dec. 9, 2010

(54) METHOD OF PRODUCING AN AUTO CONTROL SYSTEM FOR ATOMIZING ALUMINUM TO COAT METAL PARTS

(76) Inventors: Albert D'Alisa, Pound Ridge, NY (US); Scott W. Frey, Pound Ridge, NY (US)

Correspondence Address: Keohane & D'Alessandro, 1881 Western Avenue, Suite 180, Albany, NY, 12203, US

(21) Appl. No.: 12/792,125

(22) Filed: Jun. 2, 2010

Related U.S. Application Data
(60) Provisional application No. 61/183,677, filed on Jun. 3, 2009.

(51) Int. Cl. B05D 1/02; B05C 5/00

(52) U.S. Cl. 427/422; 118/696

(57) ABSTRACT

The present invention provides automated, computer-controlled apparatus and methods for coating an object comprising iron with aluminum or an alloy comprising aluminum or another alloy or metal suitable for application by use of heating with an induction coil or air or both. A computer system monitors and controls one or more heating systems to heat aluminum to a desired temperature and determine when an article is to be coated or sprayed with liquid aluminum from one or more atomizing spray nozzles connected directly or indirectly to a container having liquid aluminum therein. Other computerized control methods and sensors can be implemented in order to effectively heat the air or gas which is to be used to either melt or assist in the propelling of the aluminum or alloy which is to be used for coating.

### CROSS-REFERENCE TO RELATED APPLICATION

This application claims priority to co-pending provisional patent application Ser. No. 61/183,677, filed on Jun. 3, 2009, entitled “Method of Producing an Auto Control System for Atomizing Aluminum to Coat Metals”, and having Attorney Docket No. ECHE-0009PV, the entire contents of which are herein incorporated by reference.

### FIELD OF THE INVENTION

The present invention relates to apparatus and methods for coating iron articles and objects with one or more layers of aluminum or metals containing aluminum or other suitable metals or metal alloys. More specifically, this invention relates to apparatus and methods that are useful in coating iron articles and objects with aluminum and other metals containing aluminum, by controlling parameters involved in the coating process and systems.

### BACKGROUND OF THE INVENTION

Many efforts have been made over the years to coat iron articles and objects with a layer of aluminum. The following U.S. patents provide examples of such efforts. Hanink et al., U.S. Pat. No. 3,065,107, issued Nov. 20, 1962, describes the use of an aluminum paint or paste that is applied to a metal valve, which is then immersed in a molten salt bath to heat the article and melt the aluminum.

DeWalt, U.S. Pat. No. 4,036,670, issued Jul. 19, 1977, describes a method of making tool steel that involves protecting the steel from decarburization during heating by a metal layer which may be aluminum. DeWalt describes the spraying of an iron article with aluminum to obtain a protective coating.

Yet another approach is described in Singer et al., U.S. Pat. No. 4,657,787, issued on Apr. 14, 1987. In Singer, aluminum is heated and flow coated onto a ferrous strip.

Still another approach focuses on improvements of the nozzle of the spray gun used to spray a metal onto an object to obtain a coating. For example, Ayers et al., U.S. Pat. No. 4,619,845, issued Oct. 28, 1986, describes various types of spray nozzles jets that may be used to spray metal onto an object to be coated.

More recently, it has been found that a hard and durable aluminum coating may be obtained with other apparatus and methods. In Upchurch, U.S. Pat. No. 6,913,841, issued Jul. 5, 2005, apparatus and methods are described in which aluminum may be sprayed onto a heated iron article.

Efforts to use cost-effective, automated systems and methods to coat iron articles with aluminum has not been successful to our knowledge. For example, the process and apparatus described in Singer, noted above, requires reducing pressure and utilizes extremely high temperatures. Such an approach therefore involves costly and capital-intensive equipment. Moreover, such an approach requires a substantial amount of energy for its operation, thus increasing costs even further.

Some industries have developed apparatus and methods for automating the process of painting iron articles. Examples of such efforts include Anderson et al., U.S. Pat. No. 7,208,046, issued on Apr. 24, 2007; Nobutoh et al., U.S. Pat. No. 6,977,012, issued on Dec. 20, 2005; and Tsuruta et al., U.S. Pat. No. 4,241,646, issued on Dec. 30, 1980. In addition to such efforts, some have developed remotely controlled spray guns, robotic positioners, and the like for automating a painting or coating process. Examples of such efforts include Cunningham, U.S. Pat. No. 4,666,086, issued on May 19, 1987; Caldarone et al., U.S. Pat. No. 6,935,550, issued on Aug. 30, 2005; Coulibaly et al., U.S. Pat. No. 6,444,273, issued on Sep. 3, 2002; and Gibson et al., U.S. Pat. No. 6,548,115, issued on Apr. 15, 2003.

None of the foregoing teaches or discloses the apparatus and methods of the present invention as detailed in specific embodiments below and as set forth in the claims.

### SUMMARY OF THE INVENTION

The present invention provides an auto controlled atomized aluminum, or aluminum metal alloy, coating apparatus that enables a memory in the control system to be pre-programmed to include the size and shape of all products to be coated by the machine as well as the thickness to be applied. To attain this, the present invention utilizes a memory storing device which stores the style sequences, target thickness values, and job instructions to be performed. The present invention also provides a coating application apparatus and method well suited for use in a coating of metals with atomized aluminum, or aluminum metal alloy, on a production coating line that provides automatic control of the spread rate of atomized aluminum, or aluminum metal alloy, applied to a substrate. The conventional trial and error method of manually adjusting the height of a coating gun to adjust the spread rate is instead improved upon by utilizing a controller, actuator, and various sensors in conjunction with a novel control algorithm to achieve continuous automatic spread rate and thickness control.

In one embodiment, a method is provided for coating an iron article with aluminum or an aluminum metal alloy that includes the step of heating air to a preselected temperature with at least one electric induction heating system and delivering the heated air through insulated tubing to a container with solid aluminum therein to heat the aluminum to provide liquid aluminum. The aluminum, or aluminum metal alloy, can be heated by the air and/or the induction coil independently, or in combination, monitoring the temperature of the aluminum or aluminum metal alloy, providing an iron article and locating the iron article under a nozzle connected via tubing to the container, projecting the heated air and a preselected amount of liquid aluminum from the container through the nozzle onto at least a selected portion of the surface of the iron article, and providing a computer system having a memory and programs installed and executing on the computer, wherein the computer is connected to the container, and wherein the computer is programmed to determine when the aluminum, or aluminum metal alloy, has reached a preselected temperature and when at least a portion of the iron article is located at a preselected location relative to the nozzle, and wherein the computer is connected to the nozzle and is programmed to send a signal to the nozzle instructing it to release a preselected amount of aluminum, thereby resulting in the nozzle spraying a preselected amount of the aluminum, or aluminum metal alloy, onto the selected portion of the surface of the iron article. The control computer monitors the temperature and the pressure of the heated air. The temperature controlled heated air is a distinction from any known prior art. Heating the air removes oxygen content from the air that is used to project the heated aluminum or suitable alloy. The practice of heating the air reduces the presence of oxides in the coating, thus making it a more consistent and suitable for spray coating. The control computer and sensors, through the computerized monitoring system which monitors air temperature and oxide content, adjust the air temperature accordingly. Many coatings using methods of atomizing or melting aluminum or alloys for coatings are done in an atmospheric pressure reducing environment to reduce the oxygen content and therefore reduces the rate of oxidation of the aluminum or aluminum metal alloy. The art of heating the air also reduces oxygen content and therefore reduces the rate of oxidation of the aluminum or aluminum metal alloy. The computerized mechanisms that monitor the heating temperatures and pressures contribute to the effectiveness and suitability of the application process which directly affect the quality, consistency, and durability of the coating. Although aluminum is suitable for use in the process, various other metals and alloys and combinations can be used.

Accordingly, it is an object of the invention to provide an apparatus useful in coating an iron article with one or more layers of aluminum, or an aluminum metal alloy, in a consistent and uniform manner. It is another object of the invention to provide an apparatus useful in coating an iron article with one or more layers of aluminum, or an aluminum alloy, or other suitable alloys in a less expensive manner. It is yet another object of the invention to provide an apparatus for automatically controlling a process of coating an iron article with one or more layers of aluminum, or an aluminum metal alloy, in a consistent and uniform manner. It is yet another object of the invention to provide efficient and lower cost methods useful in coating an iron article with one or more layers of aluminum, or an aluminum metal alloy, in a consistent and uniform manner.

These and other objects of the embodiments of the present invention as described below will be evident from the following description, which is illustrative only and does not restrict the spirit and scope of the invention, which is to be measured solely by the claims.

### BRIEF DESCRIPTION OF THE DRAWINGS

FIG. 1 shows a diagram of the multi-component configuration according to one embodiment of this invention.

The drawing is not necessarily to scale. The drawing is merely a schematic representation, not intended to portray specific parameters of the invention. The drawing is intended to depict only a typical embodiment of the invention, and therefore should not be considered as limiting the scope of the invention. In the drawing, like numbering represents like elements.

### DETAILED DESCRIPTION OF THE INVENTION

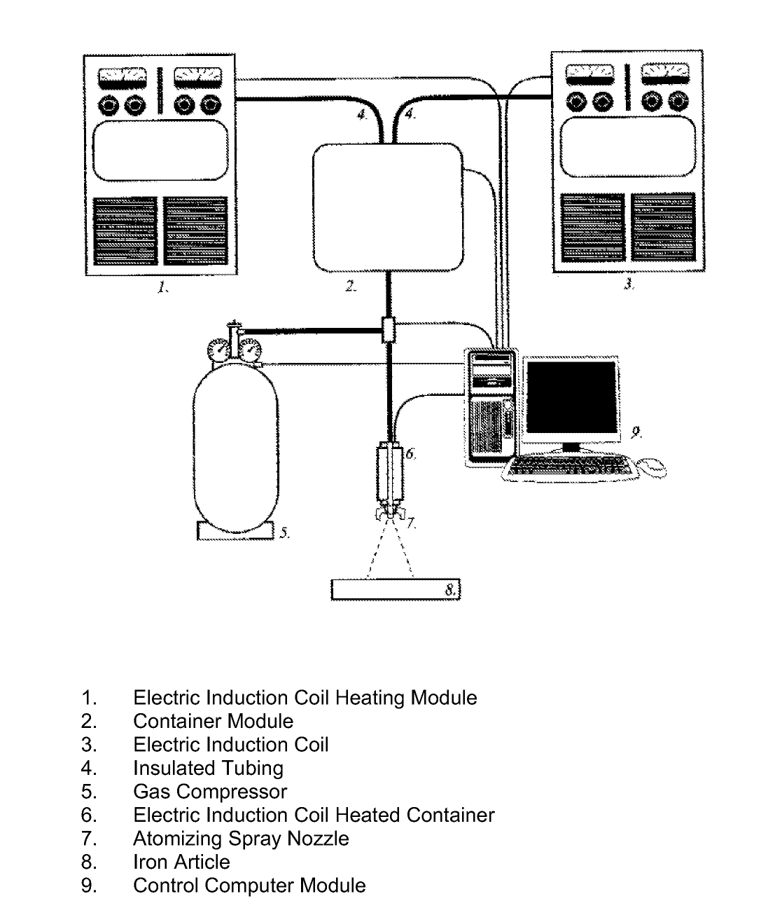

Embodiments of this invention are directed to a process for coating iron articles 8 with aluminum or aluminum metal alloys. Now with respect to FIG. 1, a multi-component configuration according to one embodiment of this invention is shown. A conveyor module carrying the iron articles 8 moves continuously through the open-ended bottoms of a coating station. In each booth, atomized aluminum, or an aluminum metal alloy, is ejected under pressure through a downwardly directed atomizing spray nozzle 7. The atomizing spray nozzle 7 is part of the aluminum, or aluminum metal alloy, and gas projection module, which also includes the electric induction coil heated container 6. The coating pattern envelopes the entire width of the object as they move through the station. The edges of the coating pattern extend beyond the edges of the objects, creating an over coating area. The over coating metal material drains through a trough at the bottom of the station and is recovered for reuse with a conventional recycle circuit comprising a recycling tank and a means of placing the over coating metal materials into a storage area for future use.

The amount of aluminum, or aluminum metal alloy, applied to each layer on the object at a given flow rate depends on the distance from the atomizing spray nozzle 7 to the surface of the iron article 8 to be coated by the projection module. Spread rates are measured using a standard sized metal test strip (nominal thickness of about 1/16″ according to one embodiment of the invention) that is placed on the conveyor and passed through the coating station. The amount of aluminum, or aluminum metal alloy, on the test strip is determined as the difference in the weight of the test strip before and after coating; the spread rate is determined from a chart which converts the weight difference to per-unit densities, based upon the top surface area of the test strip. Once the desired spread rate has been achieved, the gun is fixed at a height above the conveyor module corresponding to the desired spread rate. These sequences shall correspond with a predetermined speed of the conveyor.

A related problem is the effect of variations in the temperature of the item to be coated and the aluminum, or aluminum metal alloy, that it will be coated with on the set-up or thickening of the applied metal prior to coating. At the time of coating, a temperature monitoring module utilizes an integrated series of sensors which detect and relate information as to the temperature of the area where the coating will take place in addition to the temperatures of the iron article 8, atomizing spray nozzle 7, insulated tubing 4, and container module 2, as well as other factors such as air content/makeup which can vary at different altitudes or different humidity levels which may affect the coating process and curing times. In this method, the control means is caused to position the atomizing spray nozzle 7, with the actuator, in accordance with the coating function, including storage of an initial data values. The atomized aluminum, or aluminum metal alloy, coating control system material is supplied under pressure, supplied by the gas compressor 5, through the electric induction coil heated container 6 to the atomizing spray nozzle 7. A test piece of material is conveyed through the coating pattern on the conveyor. A determination is made from the test strip of an actual spread rate. Still another aspect of the invention resides in machine readable storage media storing a program which when executed enables a controller of the atomized aluminum, or aluminum metal alloy, coating control system apparatus to maintain a target spread rate. The machine readable storage media is part of the control computer module 9.

The control provided by the stored program includes computing a target position of the movable coating gun assembly, which consists of the atomizing spray nozzle 7 and electric induction coil heated container 6, as a function in which a distance from the atomizing spray nozzle 7 to the surface of the iron article 8 to be coated varies to a proportional relationship to a target spread rate, and controlling the actuator to move the atomizing spray nozzle 7 to the computed target position in order to maintain a target spread rate on the coating surface of the iron article 8. The present invention relates generally to a method of an auto controlled atomized aluminum coating apparatus of the type having one or more coating stations. In each coating station, there is at least one moveable atomizing spray nozzle 7 and conveyor module for transporting objects of diverse geometry past the coating station. More particularly, the invention is directed to an improved control system for automatically regulating the operation of a coating gun assembly, which consists of the atomizing spray nozzle 7 and electric induction coil heated container 6, in accordance with information contained in a memory which relates to the size and style of the iron article to be coated as well as the desired thickness of the aluminum, or aluminum metal alloy, coating.

As an object, such as a piece of steel sheet, beam, or other form of steel, enters the job input station, an operator enters the style, shape, etc., of the piece of steel to be coated in addition to inputting the desired coating thickness data into a register. This data is stored in the job portion of the memory until it is later retrieved at the time the job actually enters the coating station. Each job is stored in the memory in sequence so that the job can be operated upon in sequence at each coating station. The storage of this sequence in the memory allows the retention of the sequence in the event of the power failure. As the item passes to the coating station, the job data information is compared to the pre-programmed information within the memory. If a match occurs, the pre-programmed information in the memory then actuates the coating guns in each of the coating stations so as to move the atomizing spray nozzles 7 to the proper position for coating. When in the proper position, the memory then actuates the guns to specific positions and selects the proper thickness to coat the iron article 8 object. After the item has left the several coating stations, the pre-programmed information is retained in the memory of the control computer module 9.

Therefore, an object of the present invention is the provision of the atomized aluminum coating control system in which various objects having diverse geometry may be coated at the plurality of the atomized aluminum coating control system stations whereby the coating stations are controlled by a control computer module 9 and as to the geometry of the parts to be coated is retained in a memory unit. It shall be further disclosed that all the above information can be utilized to prepare any of the substrates to be coated. Such preparing shall include, but not be limited to, cleaning, etching, steel shotting, and sanding of the substrate to be coated. The information on the geometries of the objects can be utilized for preparing the substrates for future coating through these methods.

The control effectively compensates for variations in process parameters (e.g. flow rate, conveyor line speed, atomized aluminum speed exiting the coating gun, coating temperatures, and substrate temperatures). The controller is easily calibrated, without the need to obtain accurate initial values of the process parameters, through the use of the test strip coating thickness calibration process. The control computer module 9 controls the atomized aluminum coating system apparatus including a coating station having at least one coating gun, consisting of the atomizing spray nozzle 7 and the electric induction coil heated container 6, and a conveyor module for transporting objects of diverse styles. The control system includes input means for depositing different sets of data into the memory of the control computer module 9, some of the data pertaining to predetermined positions of an object of predetermined style and others being in a second set representative of the style of a specific object transported by the conveyor.

The control system further includes means for supplying an increment signal representative of the position of an iron article 8 object transported by the conveyor module relative to the coating station, and a comparison means for comparing the increment signal and a specific one of the data values in the second set with the position and style information contained in data values in the first set. After locating the data having the position and style information corresponding to the location signal and the specific data of the object to be coated, an energizing signal is produced which causes the coating gun, consisting of the atomizing spray nozzle 7 and electric induction coil heated container 6, in the coating station to be positioned and actuated.

The automated system will monitor flow rate speeds of the atomized aluminum, porosity of the substrate, temperature of the atomized aluminum, temperatures of the substrate, and temperatures of the air the coating is being applied along with humidity and composition of the air the application is being applied in. When the gas is air, various geographical locations will have varying air compositional differences due to the locations, altitude, humidity, or other environmental occurrences that may either impact the coating or the substrate. One feature that the present invention provides is the optimization of the atomization of the aluminum, or aluminum metal alloy, as well as optimizing the application process for massive coating applications of various objects while controlling speed and curing times and environmental conditions. The automated system will improve safety as workers shall be either maintaining or monitoring the system remotely and remain at a safe location relative to the substrates to be coated and the heated atomized aluminum, or aluminum metal alloy, coating being applied.

As shown in FIG. 1, the system includes a control computer module 9. The control computer module 9 is connected to an electric induction coil heating module 1, as well as to an electric induction coil 3. The control computer module 9 is also connected to a container module 2, to a gas compressor 5, to the electric induction coil heated container 6, and to an atomizing spray nozzle 7. As shown in FIG. 1, the atomizing spray nozzle 7 is located above the iron article 8. A mist of aluminum is being sprayed from atomizing spray nozzle 7 onto a top surface of the iron article 8 object. It can be seen that the gas compressor 5 is connected to insulated tubing 4 which connects the container module 2 with the electric induction coil heated container 6. In addition, each of the electric induction coil heating module 1 and electric induction coil 3 are connected via the insulated tubing 4 to the container module 2.

In operation, the control computer module 9 has installed and running thereon one or more computer software programs. In accordance with the computer programs, the control computer module 9 obtains data from the various components of the system and is able to control and regulate various parameters and the operations of the components of the system. With respect to the electric induction coil heating module 1 and electric induction coil 3, the control computer module 9 is programmed so that it monitors the temperature of the air in the tubing being provided by the electric induction coil heating module 1 and electric induction coil 3. In addition, the control computer module 9 monitors the frequency and power levels of the electric induction coil 3 to ensure that, during operation of the entire system, such parameters are maintained at preselected levels.

In some operations, it will have aluminum provided and placed into the container module 2. The electric induction coil heating module 1 and the electric induction coil 3 will heat the air and send the hot air to the container module 2 via the insulated tubing module. The hot air, in turn, heats the aluminum in the container module 2. Preferably, the aluminum in the container module 2 is heated to a liquid state by heating it to a temperature slightly above the melting point of aluminum. Those skilled in the art will appreciate that higher temperatures may be desired in some applications, and that lower temperatures may be applied once the aluminum in the container module 2 has reached a liquid state. Yet another temperature will be applied if the metal placed in the container module 2 is an aluminum metal alloy.

Still referring to FIG. 1, a junction connects sections of the insulated tubing 4 which carries the heated liquid aluminum from the container module 2, with another section of insulated tubing 4, which connects with the gas compressor 5. In operations of the aluminum coating system, the control computer module 9 monitors and controls the operation of gas compressor 5 so that a preselected and desired amount of air is compressed and delivered under pressure into the insulated tubing 4 by the gas compressor 5. In addition, the control computer module 9 monitors and controls the amount of aluminum fed by the tubing from the container to the junction, as well as the amount of, and timing of, when the liquid aluminum under pressure is released from the junction to the tubing. At preselected times and intervals, the control computer module 9 is programmed to allow a certain amount of the liquid aluminum (which is under pressure due to the pressurized air provided from the gas compressor 5) to enter the electric induction coil heated container 6 via insulated tubing 4.

In operation, the control computer module 9 is also programmed to monitor and control the electric induction coil heated container 6 so that it alternatively holds and releases the liquid aluminum under pressure received via insulated tubing 4. As shown in FIG. 1, the electric induction coil heated container 6 is also connected to the control computer module 9. At one of its ends (the lower end as shown in FIG. 1), the electric induction coil heated container 6 has an attached atomizing spray nozzle 7. The atomizing spray nozzle 7 is designed and adapted so that a desired spray pattern of the liquid aluminum is obtained when the control computer module 9 sends a signal to the electric induction coil heated container 6 for the release of the liquid aluminum by the electric induction coil heated container 6. As shown, a spray or mist of liquid aluminum is sprayed onto the object 8.

Those skilled in the art will appreciate that the iron article 8 may be any type or shape of article that comprises iron, including articles made of different types of steel and steel alloys. Similarly, those skilled in the art will appreciate that although reference in made herein to aluminum, aluminum alloys may be used in various purity related grades of aluminum, depending on the application involved. The iron article 8 may be any type of article to be coated, including pipe, sheets, joints, struts, bolts, and so forth. Although the operation of the system as described involves the use of compressed air and the use of heated air, those skilled in the art will appreciate that other gasses may be used. However, we believe that the use of atmospheric air will provide acceptable results without the added cost involved in connection with the use of alternate gasses.

The control computer module 9 has software installed and running that allows the control computer module 9 to monitor and control the operations of the system and its components. One embodiment of the operation of the system is as follows. An operator can initiate the operation of the system by providing an input for the control computer module 9 to begin executing the programs or program, including providing an input of the type, size, or other characteristics of the iron articles 8 to be coated with aluminum by system. The control computer module 9 has stored in memory appropriate operating parameters and programs for monitoring and controlling the operation of the system.

Once operation commences, the control computer module 9 provides appropriate signals to heating systems to begin heating air therein. In the case of heating systems, the heating system begins heating compressed air provided thereto by compressor (which begins operation upon receiving the appropriate signal from control computer module 9). As shown, the heated air from the heating systems is then fed, via insulated tubing, to a container into which an operator may place aluminum in solid, powder, or other form. The heated air provided to the container then heats the aluminum until it reaches a liquid state. The control computer module 9 monitors the temperature of the aluminum in containers via a sensor (not shown), so that the control computer module 9 detects when the aluminum in the container has reached a preselected temperature that matches a threshold value stored in the memory of the control computer module 9. At that point, the control computer module 9 sends an appropriate signal to the conveyor module so that it moves a preselected distance so that an article placed on the conveyor module is moved into the cleaning system. The cleaning system may provide for various types of cleaning of the article including chemical washes. In the preferred embodiment, the cleaning system would utilize an abrader that abrades the surface of the article.

After a preselected time stored in memory of the control computer module 9, the control computer module 9 then sends an appropriate signal so that the conveyor module again moves a preselected distance, such that an article is moved from inside the cleaning system to a location under or near the atomizing spray nozzles 7. At that point, the control computer module 9 then sends an appropriate signal to containers to require them to release a preselected amount of liquid aluminum therein onto the article. The control computer module 9 can be programmed, and the location and configuration of the atomizing spray nozzles 7 can be selected to obtain a desired spray pattern and also the desired amount and timing of the aluminum sprayed onto the article. In addition, the control computer module 9 can be programmed to release separate sprays of liquid aluminum multiple times or to time the release of liquid aluminum through atomizing spray nozzles 7 separately. Once the preselected amount and number of sprays of liquid aluminum onto the article is completed, the control computer module 9 provides the conveyor with an appropriate signal instructing the conveyor module to move again so that another article is located near or under the atomizing spray nozzles 7 as may be desired, and the previously coated article is moved away.

Those skilled in the art will appreciate that, although the conveyor module is described as a conveyor belt which moves in a single direction (e.g. left to right) the conveyor module may be any one of a number of conveyor systems for moving the article in multiple directions. For example, the conveyor module can hold the article from above so that article is hanging, or the conveyor module can hold the article from one or both sides. In addition, the atomizing spray nozzles 7 can be moved relative to the article in a preselected pattern. Moreover, the atomizing spray nozzles 7 can be located above or below, or on either or both sides of the iron article 8, so that any or all of the surfaces of the article can be coated as desired. Alternatively, the atomizing spray nozzles 7 can be provided so that they are operable and move independently of each other. For example, three atomizing spray nozzles 7 can be located relative to the article such that they are positioned 120 degrees from each other in a circle around the article and move in a pattern so that each of the atomizing spray nozzles 7 essentially covers a third of the article, thus resulting in a faster process for coating an article. Moreover, the control computer module 9 can be programmed so that the article can be moved at the same time as the atomizing spray nozzles 7 are moved. Such movements can be in any three-dimensional direction and will depend on the nature of the article to be coated and the nature of the coating desired. For example, a length of pipe could be rotated around its longitudinal axis while one or more atomizing spray nozzles 7 are moved from one end of the pipe to the other end.

The control computer module 9 can be programmed to have multiple programs in its memory so that an operator can select the article and also the desired pattern of the desired coating and the thickness of the desired coating, with the control computer module 9 then executing the program residing in its memory to monitor and control the components of the system such that the appropriate amounts of liquid aluminum are sprayed onto the appropriate surfaces of the article at the appropriate times, thereby providing a uniform and consistent coating of the article with the desired coating.

Although not shown, a number of sensors can be included in the system. For example, one or more sensors can be provided to monitor the temperature of the aluminum in the container and provide that information to the control computer module 9 on a continual basis. Likewise, the control computer module 9 is provided the frequency of the AC current and the voltage provided by each of the induction heating systems. The control computer module 9 can be programmed so that if the temperature of the aluminum in the container drops below a certain level, or does so for a certain time period, the control computer module 9 can send an appropriate signal to one or more of the heating systems to increase the frequency and/or the voltage, or otherwise change the operating parameters as desired. For example, if the temperature of the aluminum drops to a second level, the control computer module 9 can be programmed to shut down the heating systems and the other components of the system, such as if the temperature is so low that no liquid aluminum is likely to remain in the container. The control computer module 9 may be programmed so that, if a particular situation exists (e.g., the temperature of the aluminum drops below a certain level for a preselected period of time and the spray pattern is of a preselected type intended to obtain a fine coating), the control computer module 9 sends one or more appropriate signals to the heating systems and the atomizing spray nozzles 7 and/or to slow the movement of the atomizing spray nozzles 7 and thereby provide more aluminum sprayed per unit of time, or to alternatively speed up the movement of the atomizing spray nozzles 7 to thereby provide less aluminum sprayed per unit of time.

Those skilled in the art will appreciate that more or less components such as those shown in and described above may be used. For example, instead of the two heating systems shown, additional heating systems may be used if desired, and the control computer module 9 may be programmed accordingly to monitor and control the additional heating systems as well. Similarly, those skilled in the art will appreciate that more or less atomizing spray nozzles 7 may be used as may be deemed desirable, and the control computer module 9 can be programmed to control the greater or lesser number of atomizing spray nozzles 7 as desired.

It is apparent that there has been provided with this invention an apparatus and methods that are useful in coating iron articles 8 and objects with aluminum and aluminum metal alloys by controlling specific parameters involved in the coating process and systems. While the invention has been particularly shown and described in conjunction with a preferred embodiment thereof, it will be appreciated that variations and modifications will occur to those skilled in the art. Hence the embodiments shown and described in the drawings and the above discussion are merely illustrative and do not limit the scope of the invention as defined in the claims herein

What is claimed is:

1. An aluminum coating system, comprising:
an iron article for coating;
a module for heating a gas to a preselected temperature and delivering the heated gas through insulated tubing to a container with aluminum, or an aluminum metal alloy, inside;
a module monitoring the temperature of the aluminum, or aluminum metal alloy;
a module for conveying the iron article into place relative to an atomizing spray nozzle connected to the container;
a module for projecting the heated gas and a preselected amount of liquid aluminum from the container through the atomizing spray nozzle onto a surface of the iron article; and
a module for a control computer system to control the other modules via connections to the container

2. The aluminum coating system according to claim 1, wherein the gas is air.

3. The aluminum coating system according to claim 1, wherein the gas is heated with an electric induction coil.

4. The aluminum coating system according to claim 1, wherein the gas and aluminum, or aluminum metal alloy, is heated by an induction coil in the same container and with sufficient energy to cause the aluminum, or aluminum metal alloy, to melt and allowing it to be propelled through an atomizing spray nozzle.

5. The aluminum coating system according to claim 2, wherein the method for heating the air alters the composition of the air so that it creates a suitable carrier gas for the propulsion of the aluminum, or aluminum metal alloy, while reducing the oxygen content from before the method of heating was applied.

6. The aluminum coating system according to claim 1, wherein any area that is in contact with the heated air between the initial gas heating step and exiting the atomizing spray nozzle are heated with additional AC electric induction coils, DC electric induction coils, flames, or other heating methods familiar to one skilled in the art. This would include the tubing that delivers the heated gas to the container or the container which holds the aluminum, or aluminum metal alloy.

7. The aluminum coating system according to claim 1, wherein the control computer system is electronically connected to the induction coil and is programmed to send one or more appropriate signals to instruct the electric induction coil to maintain an alternating current in the frequency range of 20 to 80 kHz and apply a voltage in the range of 200 to 700 volts.

8. The aluminum coating system according to claim 1, wherein the module for conveying the iron article is controlled by the control computer system and conveyance of the iron article or movement of the atomizing spray nozzle before, during, and after the projection step is included and the conveyance of the iron article is conducted on a conveyor belt, metal hook carrier, or other mechanism that is familiar to one skilled in the art. The movement of the atomizing spray nozzle could be accomplished through pneumatic, robotic, or similar mechanical controls.

9. The aluminum coating system according to claim 1, wherein additional processing preparation steps are included before the coating steps including:
an abrasive process which includes a control computer system which sends one or more appropriate signals to the abrader to a spray metal shot on the article in a preselected pattern and for a preselected time period; or
a chemical cleaning processing step with either a bath, spray, or other application method familiar to one skilled in the art.

10. A computer system for controlling an aluminum coating system, comprising:
at least one processing unit;
memory operably associated with the at least one processing unit; and
a utility stored in the memory and executable by the at least one processing unit, the utility comprising:
a module for overlaying a multidimensional grid throughout the aluminum coating system,
a module for tracking the location of the iron article and atomizing spray nozzle,
a module for monitoring temperature sensors,
a module for sending adjustment signals to the connected atomizing spray nozzle, heating elements,
a module for controlling the conveyance of the iron article and movement of the atomizing spray nozzle components, and
a module for displaying temperature values, iron article locations, atomizing spray nozzle locations, target temperature values, and movement data to a Graphical User Interface.

11. The computer system for controlling an aluminum coating system according to claim 8, the module for sending adjustment signals to connected heating elements is used to heat air.

12. The computer system for controlling an aluminum coating system according to claim 8, the module for sending adjustment signals to connected atomizing spray nozzle, coordinates temperature adjustments of gas or aluminum materials with an electric induction coil.

13. The computer system for controlling an aluminum coating system according to claim 8, the module for sending adjustment signals to connected heating elements, coordinates temperature adjustments of gas or aluminum.

14. The computer system for controlling an aluminum coating system according to claim 8, the module for sending adjustment signals to connected heating elements, wherein the gas and aluminum, or aluminum metal alloy, is heated by an induction coil in the same container and with sufficient energy to cause the aluminum, or aluminum metal alloy, to melt and allowing it to be propelled through an atomizing spray nozzle.

15. The computer system for controlling an aluminum coating system according to claim 8, the module for sending adjustment signals to connected heating elements, wherein the method for heating the air alters the composition of the air so that it creates a suitable carrier gas for the propulsion of the aluminum, or aluminum metal alloy, while reducing the oxygen content from before the method of heating was applied.

16. The computer system for controlling an aluminum coating system according to claim 8, a module for sending adjustment signals to connected heating elements, wherein the control computer system is electronically connected to the induction coil and is programmed to send one or more appropriate signals to instruct the electric induction coil to maintain an alternating current in the frequency range of 20 to 80 kHz and apply a voltage in the range of 200 to 700 volts.

17. The computer system for controlling an aluminum coating system according to claim 8, a module for controlling the conveyance of the iron article and movement of the atomizing spray nozzle components wherein the module for conveying the metal article is controlled by the control computer system and conveyance of the iron article or movement of the atomizing spray nozzle before, during, and after the projection step is included and the conveyance of the iron article is conducted on a conveyor belt, metal hook carrier, or other mechanism that is familiar to one skilled in the art. The movement of the atomizing spray nozzle could be accomplished through pneumatic, robotic, or similar mechanical controls.

18. The computer system for controlling an aluminum coating system according to claim 8, a module for controlling the conveyance of the iron article and movement of the atomizing spray nozzle components, wherein additional processing preparation steps are included before the coating steps including:
an abrasive process which includes a control computer system which sends one or more appropriate signals to the abrader to spray metal shot on the article in a preselected pattern and for a preselected time period; or
a chemical cleaning processing step with either a bath, spray, or other application method familiar to one skilled in the art.

19. A method for deploying an aluminum coating system in a computer system, comprising:
provide the computer infrastructure operable to:
a module for tracking the location of an iron article and an atomizing spray nozzle;
a module for monitoring temperature sensors;
a module for sending adjustment signals to the connected atomizing spray nozzle and heating elements;
a module for controlling the conveyance of the iron article and movement of the atomizing spray nozzle components; and
a module for displaying temperature values, the iron article locations, the atomizing spray nozzle locations, target temperature values, and movement data to a Graphical User Interface.

20. The method for deploying an aluminum coating system in a computer system according to claim 19, a module for sending adjustment signals to the connected heating elements, wherein the heating elements heat air and the method for heating the air alters the composition of the air so that it creates a suitable carrier gas for the propulsion of the aluminum, or aluminum metal alloy, while reducing the oxygen content from before the method of heating was applied.
